(19) United States
(12) Patent Application Publication
(10) Pub. No.: US 2006/0022424 A1
(43) Pub. Date: Feb. 2, 2006

(54) Torsion spring cartridge

(76) Inventor: Norm Reynolds, Muskego, WI (US)

Correspondence Address: FOLEY & LARDNER LLP, 777 EAST WISCONSIN AVENUE, SUITE 3800, MILWAUKEE, WI, 53202-5308, US

(21) Appl. No.: 10/909,176

(22) Filed: Jul. 30, 2004

(51) Int. Cl. B60G 11/23

(52) U.S. Cl. 280/124.169

(57) ABSTRACT

A torsion spring cartridge for an axle tube. The torsion spring cartridge includes a bearing housing configured to be removably mounted in an non-rotating relation in the axle tube. A torque arm including a torque hub defining a plurality of pockets and mounted for reciprocal, rotatable motion in the bearing housing. A draw bar is coupled to the torque hub. A counter torque hub is configured to be positioned in the axle tube in a spaced relation to the torque hub and in a non-rotating relation to the axle tube. The counter torque hub is composed of a plurality of plates configured to receive the draw bar and defining a plurality of pockets. At least two torsion bars are mounted between the torque arm and the counter torque hub for biasing the torque arm to a neutral position. The torsion bars are not fixedly mounted in the hub pockets.

### BACKGROUND OF THE INVENTION

The present invention relates to torsion spring suspensions for vehicles, and in particular to a torsion spring cartridge.

Trailers, whether light duty or heavy duty require a suspension system to support the axle for the wheels. The suspension system is typically permanently mounted on a frame of the vehicle and generally includes shock absorbers to dampen excessive vibrations that cause poor vehicle control and excessive wear on related components. Serviceability of the suspension system, whether for replacement or repair is a time consuming and sometimes expensive procedure, particularly where as with mobile homes, there may be as many as three or more axles coupled to the frame.

Some torsion spring assemblies utilize rubber inserts as the torsional stress absorber. Such rubber inserts are sensitive to temperature changes which will affect the performance of the torsion spring assembly as the temperature varies. Other torsion spring assemblies utilize a solid counter torque block to which the torsion bars are welded or brazed or securely fastened. Over time, as the torsion spring assembly is stressed, welds tend to become brittle causing the torsion bars to disengage from the solid block counter torque hub. Another prior art torsion spring assembly folds the torsion bars back upon themselves creating a tight bend in the confines of the axle tubes of the vehicle. Such tight bends create an undue stress point in the torsion bar which can cause the torsion bar to crack or break at the bend.

Thus there is a need for a torsion spring cartridge with torsion bars that are not fixedly mounted in the torque hub pockets and counter torque hub pockets. There is further need for an axle kit for a trailer that can add axles to the trailer as determined by a user and provide for easy replacement and repair of such axle. There is an additional need for a torsion spring cartridge that provides an integral one-piece torque subassembly which combines a torque hub portion, a counter torque hub portion and a plurality of torsion bar portions as a single integrated piece for insertion in an axle tube.

### SUMMARY OF THE INVENTION

There is provided a torsion spring cartridge for an axle tube. The torsion spring cartridge includes a bearing housing configured to be removably mounted in an non-rotating relation in the axle tube. A torque arm including a torque hub defining a plurality of pockets and mounted for reciprocal, rotatable motion in the bearing housing. A draw bar is coupled to the torque hub. A counter torque hub is configured to be positioned in the axle tube in a spaced relation to the torque hub and in a non-rotating relation to the axle tube. The counter torque hub is composed of a plurality of plates configured to receive the draw bar and defining a plurality of pockets. At least two torsion bars are mounted between the torque arm and the counter torque hub for biasing the torque arm to a neutral position. The bearing housing, torque arm, torsion bars and counter torque hub are removable as a unit from the axle tube for service, replacement or repair. The torsion bars are not fixedly mounted in the torque hub pockets and counter torque hub pockets. The torsion bars can have a uniform cross section. Another embodiment of the torsion spring cartridge provides the torsion bars having a square cross section.

There is also provided an axle kit for a trailer. The trailer includes a frame. The kit includes an axle tube having two open ends and configured to couple to the frame. A torsion spring cartridge is mounted in at least one end of the axle tube. The torsion spring cartridge includes a bearing housing configured to be removably mounted in an non-rotating relation in the axle tube. A torque arm including a torque hub defining a plurality of pockets and mounted for reciprocal, rotatable motion in the bearing housing. A draw bar is coupled to the torque hub. A counter torque hub is configured to be positioned in the axle tube in a spaced relation to the torque hub and in a non-rotating relation to the axle tube. The counter torque hub is composed of a plurality of plates configured to receive the draw bar and defining a plurality of pockets. At least two torsion bars are mounted between the torque arm and the counter torque hub for biasing the torque arm to a neutral position. The bearing housing, torque arm, torsion bars and counter torque hub are removable as a unit from the axle tube for service, replacement or repair. The torsion bars are not fixedly mounted in the torque hub pockets and counter torque hub pockets. The torsion bars can have a uniform cross section. Another embodiment of the torsion spring cartridge provides the torsion bars having a square cross section.

There is also provided a torsion spring cartridge for an axle tube. The torsion spring cartridge comprises a bearing housing configured to be removably mounted in a non-rotating relation in the axle tube. A torque arm is mounted for rotary motion in the bearing housing. An integral, one-piece torque subassembly having a torque hub portion is attached to the torque arm and a counter torque hub portion is coupled to the torque hub portion with a plurality of torsion bar portions in a spaced apart relation. The one-piece torque subassembly is configured to mount inside the axle tube in a non-rotating relation to the axle tube wherein the one-piece torque subassembly biases the torque arm to a neutral position. The one-piece torque subassembly can be composed of a composite material or a metal or a combination of composite material and metal.

### BRIEF DESCRIPTION OF THE DRAWINGS

FIG. 1 is a perspective, exploded view of an exemplary embodiment of a torsion spring cartridge.

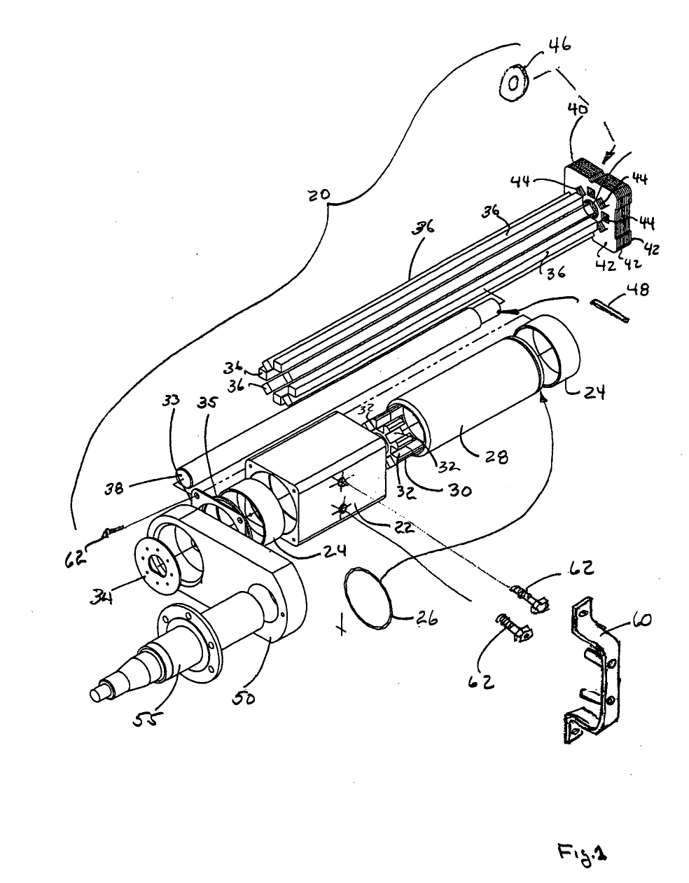

FIG. 2 is a partial plan side view and partial side sectional view of an exemplary embodiment of an assembled torsion spring cartridge mounted in an axle tube.

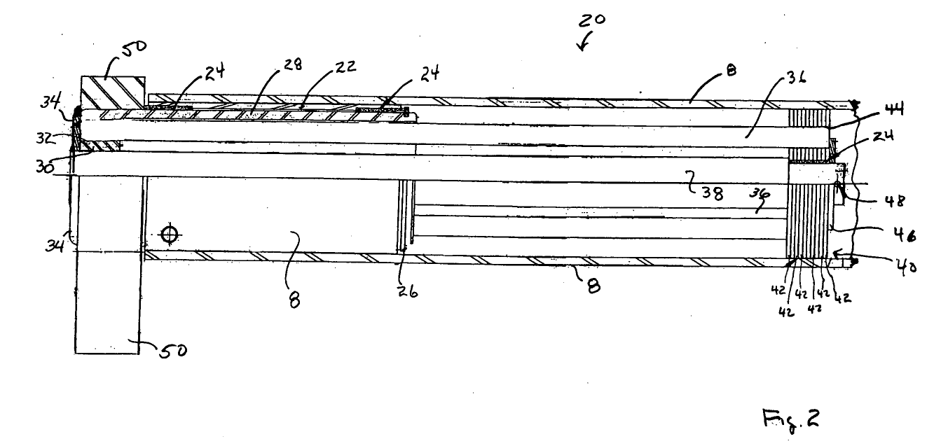

FIG. 3 is a perspective illustration of an exemplary embodiment of a torsion spring cartridge for an axle tube of the trailer, with the torsion spring cartridge aligned traverse to the direction of travel of the trailer.

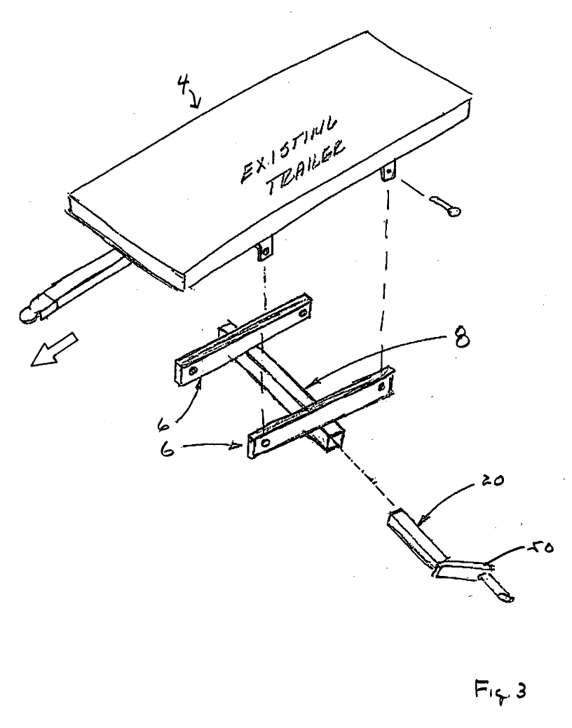

FIG. 4 is a perspective illustration of an exemplary embodiment of a torsion spring cartridge of an axle tube of a trailer, with the torsion spring cartridge aligned parallel to the direction of travel of the trailer.

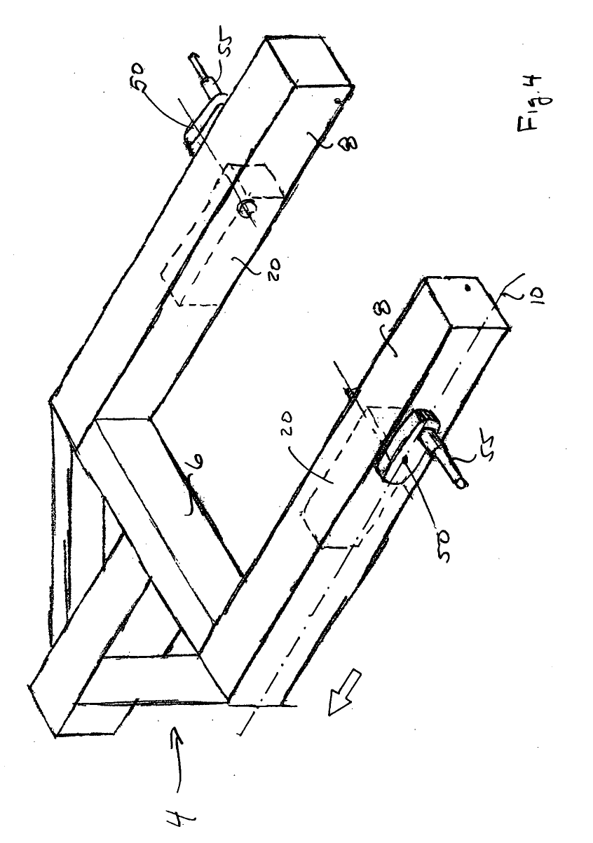

FIG. 5 is a perspective view of an exemplary embodiment of an integral, one piece torque subassembly having an integral torque hub portion, a counter-torque hub portion and a plurality of torque bar portions between the hub portions and aligned to enter a bearing housing of a torsion spring cartridge.

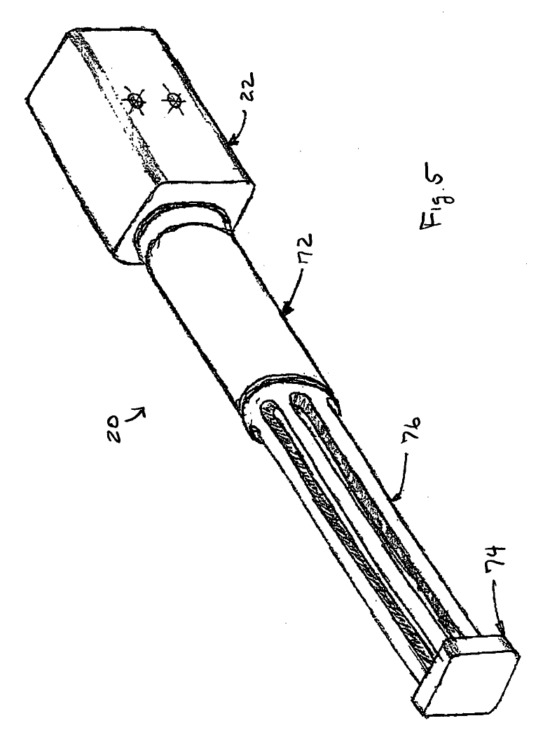

### DETAILED DESCRIPTION OF THE PREFERRED EMBODIMENTS

Typical torsion bar systems operate along the torsion bar's centerline neutral axis. If a torque is induced then released, there are no other forces other than internal friction to decay action back to reset. Used in a vehicle traveling over typical roadway that would result in constant bouncing to cargo and occupants, often to their dismay and discomfort, and cause very irregular and poor tire wear. To condition and control this effect, dampeners are installed at each wheel. Dampeners offer resistive force in one direction to counter spring released energy, causing acceptable vehicle bounce decay in providing reasonable ride quality. These dampeners require external mounting to the torsion system, increase unsprung mass, and are an additional cost for the suspension system. Further, they are effective only after sufficient displacement because of delay in internal porting for fluid designs and component movement in friction devices. Dampeners exhibit a constant single retardation value, no matter the amount of displacement induced, the energy being returned to work against, or the acceleration involved. Therefore, harsh terrain and off-road operations usually have considerably large dampeners to perform at additional cost and weight.

Exemplary embodiments of torsion spring cartridges 20 disclosed herein exhibit unique self-dampening from torsion bar 36 that is proportional in effect to load displacement. The torsion spring cartridge 20 design has a plurality of torsion bars removed from the cartridge neutral center where radial displacement occurs. When a torque is applied to the system, each torsion bar 36 not only twists in torsion, but also bends in X and Y directions to that bar. Released, the torsion bar 36 twisting acts the same in working about its centerline neutral axis. However, the X and Y external bending forces through oscillation work as a combined force to dampen the twisted torsion effect. Further, the greater the displacement, the proportionally greater X and Y bending forces for dampening effect in decaying action to normal position. This dampening is instantaneous in effect as it is part of the system. Thus, retardation effect increases with displacement increase and happens without delay. The dampening effect varies with torsion bar 36 distance from the cartridge 20 neutral center; the further the torsion bar 36 is positioned from the neutral center axis, the greater the dampening force effect.

Prior art torsion axle systems are claimed to be independent, in which a wheel moves independently of the other on the same axle system. Yet in actuality both torsion ends of the system may be too stiff, harsh in function, and resulting ride that they inhibit gains a vehicle may achieve in normal road handling and maneuverability. The concept involved is spring rate, in pounds per inch vertical wheel travel. The higher the spring rate for a given gross vehicle weight (GVW), the firmer and harsher the ride from a torsion action. Typical torsion axle systems are fixed in their design spring rate and unable to adjust from application to application. Typical rubber torsion axles are so affected by temperature extremes from cold to warm climates a normal load in the former temperature is a significant overload in the latter.

The torsion spring cartridge 20 is an independently functioning system assembly. Installing a pair of torsion spring cartridges 20 into the axle tube 8 openings creates a fully independent axle system. Unlike other torsion axle systems that are fixed in assembly, this torsion axle configuration allows cartridge preparation and change with appropriate number of torsion bars 36 for desired spring rate. Desired spring rate for each torsion spring cartridge 20 may be adjusted for use in one application to another. Also, environment and climate have no effect on performance and consistency.

There are several factors involved with ride quality conditioning for typical torsion axles, yet design limitations prevent, and sometimes prohibit, taking full advantage of these attributes. Ride quality is a desired and required feature for vehicle dynamics and performance. It is the resultant from these factors that condition the energy absorption and influence the effect from each wheel surmounting an obstacle in its path. Dampeners, anti-sway bars, and other related devices have been employed to perform conditioning to items riding or attached to the chassis. Each such piece of equipment promotes additional weight, unsprung mass, and accumulated costs to the vehicle.

Referring to the drawings, attached to the torque arm 50 is the torque hub 30 within a torque tube 28. The torque hub 30 has equally spaced pockets that are slightly larger than the torsion bar 36 section size and configuration. These pockets are placed about the hub's outside shape and has the outer wall missing. A clearance hole is placed in the center to allow drawbar 38 passage. Torque hub 30 can be made from stock using simple tooling and machines, material extrusion, laminations, precision casting, powdered metal, and the like that will permit continuous loading to the torsion bars 36. The torque tube 28 is typically available tubing cut to desired stock length and has slight boring for torsion bar 36 relief so as to prevent contact when twisted. Opposite the retaining ring 26 groove end, machining or processing is done that is slightly larger and conforms to the torque hub 30 outer configuration to specific depth. The torque hub 30 is introduced into mating torque tube 28 end and seated against residual material stops. The fitment between the two parts is a sliding-fit to push-fit that provides unstressed containment. The illustration has a square torsion bar 36 that will nest in a pocket formed by the 3 sides profiled in the torque hub 30 and the 4^{th} side from the torque tube 28.

This assembly creates a plurality of pockets 32, each conforming about the mating geometric torsion bar 36 in providing drive to and receiving from each torsion bar 36. The torque hub 30 is entrapped within the torque tube 28 by the residual material stops inside the tube and the end cap 34 fastened for example, welding, to the torque arm 50 preventing it from axial movement. As a torque force is applied from the torque arm 50 to the torque tube 28 through a fastened joint, that torque is distributed to each of the pockets 32 formed by the interior torque tube 28 surfaces and the mating torque hub 30 surfaces. Production costs are significantly reduced through considerably less machine time, material usage and scrap, and significantly reduced tooling and equipment costs and their maintenance. This creation allows more typical and less costly machining and processing to result in the same functioning single piece having geometric holes, configurations, and pockets formed or machined in pattern.

Prior art torsion cartridge designs have single outboard bearing for assembly oscillation as torque arm is loaded in vehicle suspension use. This is an unworkable practice in application and a poor one when using a center drawbar and bearinged countertorque hub used as a lever in countering chamber forces from wheel loading. Wheels operate perpendicular to the earth's surface with some slight camber inboard or outboard of the vehicle they are attached. In the case of the former, plain journal bearings will pinch and bind mating parts from high mechanical advantage wheel loading camber forces that will exhibit excessive wear on bearing top outboard and bottom inboard, thus allowing increased wheel camber and tire wear to unsafe operation. Further, torsion bars within pockets will be pinched and retarded in operation as bearing wears. In the latter case, the drawbar oscillates along the countertorque hub center axis and acts as a beam between the bearing and countertorque hub and has an outboard wheel chamber load. Beams loaded like this exhibit flexure, bowing downward, between supports, and again wearing bearings at lesser rate and gradually pinching torsion bars in operation. By substantially raising the drawbar pivot in the countertorque hub, the drawbar flexure could be compensated for in countering wheel camber forces and having an operable wheel within reasonable limits. However, the torsion bars axis are not parallel to the drawbar and will pinch and bind in operation. Also, the offset will cause interference as the cartridge is attempted to install into axle tube, requiring nontypical compensation to accommodate.

As disclosed herein, the torque hub 30 oscillates i.e., reciprocal rotatable motion, in dual torque tube bearings 24 secured within a bearing housing 22 that provides the torsion cartridge 20 the operating position within the axle tube 8. Each torque tube bearing 24 can be any typical type that allows journal operation with or without lubrication, in this case a plain bearing. The bearing housing 22 and inboard and outboard torque tube bearings 24 are contained between the torque arm 50 and retaining ring 26 faces. The outboard torque tube bearing 24 face and inboard torque tube bearing 24 face each periodically accept end thrust from torque arm 50 and retaining ring 26, respectively, during operation. Both thrust forces are, in turn, pressed against bearing housing 22 separated shoulders to limit effect. A radial seal 35, O-ring, lip seal, and the like is provided to prohibit debris from entering and damaging torque tube 28 and bearing housing 22 mating surfaces can be installed. A seal plate 33 would capture seal inside bearing housing 22 and also becomes the thrust surface against the torque arm 50. It is located and secured to the bearing housing 22 with mounting fasteners 62, for example, screws. The bearing housing 22 outer surfaces conform to axle tube 8 interior to allow containment with installation and removal on demand. It can be machined or processed material, such as extrusion, casting, powdered metal, or the like for lowest production cost while providing sufficient strength to maintain induced loads. The torsion spring cartridge 20 is retained within the axle tube 8 with securing to prevent movement out of axle tube 8 mouth fasteners 62, for example bolts. A lubrication fastener 62 allows securing with a lubrication passage into the bearing housing 62 lubrication chamber between the torque tube bearings 24.

Torque tube bearings 24 are well separated and retained within the bearing housing 22 to significantly support the torque tube 28 in maintaining induced camber forces from torque arm 50 and spindle 55 loading. In turn, the wheel coupled to the spindle 55 is maintained in proper transport position for durable operation. This is done without any other devices or means and prevents any torsion bar 36 pinching or binding from induced loading. Because the torsion spring cartridge 20 is positioned by the axle tube 8, the only movement it can make is going in or coming out of the axle tube 8. The bearing housing 22 can use other retention devices, such as dowel pins securely attached to a mounting bracket 60. The dowel pins pass through axle tube 8 holes and seat into bearing housing 22 mounting holes. The mounting bracket 60 conforms to half the axle tube 8 configuration, for example a square tube, and a mating pair can be easily secured with common reusable fastener 62, for example bolt and nut clamp. The dowels are used in shear and prevent the torsion spring cartridge 20 movement, yet allow restrained floating within axle tube 8.

Although the bearing housing 22 can be made from bar and heavy wall tube stock, it is costly. More equitable manufacturing includes material casting, material injection, extrusion, and the like. Composite materials will not exhibit corrosion problems and are electrically non-conducive. Minor secondary machining may be required to complete manufacture.

Prior art torsion spring cartridge designs had single piece countertorque hubs to absorb torsion bar loading and distributed the loads to axle tube walls. Such design requires extensive tooling. Flat bar stock has to be cut and machined to properly fit within axle tube size and configuration. Drilling specific size holes in torsion bar 36 matching pattern and quantity through workpiece. Hole position requires tight tolerance placement, thus necessitating proper tooling and equipment to repeatably perform. The final operation involves single-pass broaching with a specific size broach that is slightly larger than the torsion bar 36 section size and configuration.

Disclosed herein is a countertorque hub (40) that has a pocket hole pattern 44 as that formed by the torque hub 30 and torque tube 28. The countertorque hub 40 is a lamination assembly of individual plates 42 having accurately processed geometric hole size and configuration placement in a pattern, such as from punches in a stamping operation. When stacked and secured together with common methods, this assembly creates a plurality of pockets 44, each conforming about the mating geometric torsion bar 36, in receiving drive from and providing drive to each torsion bar 36. These pockets 44 absorb induced geometric torsion bar 36 loading forces from all faces and distribute these forces to the outer edges against the axle tube 8 to assume the torque reaction. The countertorque hub 40 is processed, such as laser cutting or stamping, with an outer configuration that closely mates with axle tube 8 inner surfaces and may have a relief included to bridge over axle tube 8 weld flashing. The countertorque hub 40 also has a drawbar bearing 24 that allows drawbar 38 oscillation, from the torque arm 50 working, within the stationary lamination hub assembly 40. A laminated countertorque hub 40 allows more typical and less costly machining and processing to result in the same functioning single piece having geometric holes, configurations, and pockets formed in pattern that closely fits within axle tube 8.

Prior art torsion cartridge designs have had the multiple torsion bar ends attached to torque and countertorque hubs, especially those bars in circular section in which positive drive is required to twist the bar in torsion. Attachment through heat application, such as welding or soldering, causes annealing ends of typically heat treated steel torsion bars. As each torsion bar is twisted, it wants to maintain original length and contracts from angular displacement, even though the assembly is fixed length. This change in toughness creates weak spots in the steel torsion bar ends, that when cyclically loaded and contracted, the torsion bars are cyclically stretched and relaxed to soon exhibit tensile fatigue fracture.

As disclosed herein, each torsion spring cartridge 20 has a plurality of geometric torsion bars 36 that nest within the torque hub 30 and countertorque hub 40 pockets 32, 44 to provide positive drive. Torsion bar 36 attachment is not required to torque hub 30 or countertorque hub 40 for desired operation. The torsion bars 36 are uniform in heat treatment, as heat is not required for nesting within pockets. As each torsion bar 36 is twisted and radially displaced about the neutral center by the torque hub 30, forces cause it to contract in length. The drawbar 38 maintains the torsion length distance between the torque hub 30 and the countertorque hub 40. To accommodate torsion bar 36 contraction, the ends slide within either of the respective pockets 32, 44 to prevent internal tensile forces in stretching the bar and fatiguing it when cyclically loaded. The practice in having geometric torsion bars 36 floating within torque hub 30 and countertorque hub 40 pockets 32, 44 prevents premature failure from cyclic tensile fatigue. Geometric torsion bars 36 can be made from numerous materials, such as steel or composites for example, to provide desired spring action and capacity. Composite materials do not exhibit corrosion problems and are electrically non-conductive. The torsion bars 36 should have a uniform cross-section along its entire length. The cross-section can be any convenient geometric shape, however the preferred cross-section is square.

Prior art torsion cartridge designs have blind hole hubs exposed to environments in retaining torsion bars. The former is a costly manufacturing process, especially for geometrically shaped torsion bar pockets. The latter allows for lesser manufacturing cost, but dirt, debris, and corrosion growth impact about the torsion bars and prevent desired operation and future servicing.

As disclosed herein, the geometric torsion bars 36 are floating within respective pockets 32, 44 during cyclic loading, the bar must be axially contained within reasonable limits. The torsion bars 36 are limited in movement by torque arm end cap 34 and drawbar end washer 46. The torque arm end cap 34 is securely attached to the torque arm 50 such as welded or bonded, and completely covers and seals torque hub 30 pockets 32 from external environment. The drawbar end washer 46 is held in position by the retaining fastener 48 for example, a pin, or the like, through the drawbar 38 cross hole. The retaining fastener 48 can also be a threaded nut, cotter pin or similar device. The secured torque arm end cap 34, drawbar end washer 46, retaining fastener 48 and drawbar 38 cross hole all limit geometric torsion bar 36 floating. Otherwise, unbound torsion bars 36 would float out of respective pockets to cause mating end deformation or total disengagement. Respective result of both events would cause poor fitting in mating parts, or torsion cartridge incapability to maintain applied loading. End cap 34 and drawbar end washer 46 can be made from various compatible materials, including composite materials that will not exhibit corrosion problems and are electrically non-conductive.

Prior art torsion spring cartridge axle tube designs have outboard mounting brackets and plates to attach to existing vehicle frame rails. Also, some axle designs have at least one axle tube crown bent downward at center to both ends to provide wheel camber compensation for proper tire wear operation. Both cases limit axle mounting and require additional clearances to allow installation. Nearly all these axle tubes are limited to typical steel tubing and formed steel bracketry.

As described herein, the axle tube 8 not only contains and secures torsion spring cartridges 20 but also accepts cartridge torsion loading and distributes to vehicle frame 6 members. Further, the axle tube 8 and the bearing housing 22 can maintain wheel camber position, and configured as a straight part, and not require additional clearances for desired installation. The axle tube 8 can be securely fixed, such as welded, bonded, or fastened, to support other structural members. Now it becomes an integral frame crossmember that allows for eliminating an existing structural crossmember. Installations would include notched or portholed vehicle or product frame members, skid frame generators for example, to accept and secure axle tube 8. The axle tube 8 can be configured, such as stepped or jointed, to allow a feature or clearance beneficial to the vehicle. Providing inboard boat propeller drive shaft clearance is an example. Further, additional mounting for other products can be fixed, such as welded or fastened, to allow a feature beneficial to the vehicle. For example, a boat roller could be securely mounted there. All these attributes can be done in preparation to any heat process, such as hot dip galvanizing or baked enamel painting, that would be detrimental to other axle systems. Axle tubes 8 can be processed from material forming, extrusion, injection, or molding for desired configuration. Composite materials will not exhibit corrosion problems and are electrically non-conductive.

Prior art torsion cartridge designs are not readily serviceable in maintenance or repair for continued operation. This is especially true for typical rubber torsion stubs and axles that are manufactured without ability to service or repair, and when inoperable are summarily scrapped and replaced with new. Multiple torsion bar designs are not that much more serviceable in maintenance or repair for continued operation, especially those with securely attached torsion bars. These too are summarily scrapped and replaced with new.

The disclosed torsion spring cartridge 20 is a uniform assembly of interchangeable components forming a single compact unit. In service the individual parts can be repaired or replaced, most of them readily, with new to regain design performance. Further, geometric torsion bars 36 can be added or removed to respectively increase or decrease load capacity, or all can be removed and replaced with new to regain original performance. Torsion bars 36 made from different materials, such as composites, can be installed in existing cartridge assembly to feature desired capacity and benefits. Since the torsion spring cartridge 20 is a uniform assembly, it will readily interchange within the same size and configuration application axle tube 8 to accommodate immediate and simple servicing the vehicle. Unlike typical torsion spring systems, these cartridges are removable and the torsion spring cartridge 20 can be used in a conversion of a conventional leaf-spring axle and one interchangeable on demand. For fleet vehicle operations, pre-serviced torsion cartridges will interchange with those in use for preventative maintenance. The replaced units then receive individual maintenance attention and stocked for future recycling.

Prior art torsion cartridge and axle spring assembly designs are manufactured from several metal and other material parts and assembled for operation. Use of these materials and processes required for production impose numerous manufacturing and product assembly limitations and conditions. Some materials require shotblasting or surface conditioning in preparation for forming or processing. Some parts require attachment, such as fastening or welding, to one another for function or operation. Rubber torsion designs typically require nitrogen freezing to contract rubber cords for assembly, then thaw for expansion in final assembly and retention. Further, when used in application these materials require additional essentials to allow continuous operation, such as paint coating for corrosion protection. Metals require heat treatment, drawing, straightening, and cleaning for durable performance.

An alternative exemplary embodiment is a torsion subassembly 70 configured as a combination of previously mentioned torque hub 30, multiple torsion bars 36 and countertorque hub 40. Eliminated from use in this subassembly are end cap 34, drawbar 38, drawbar bearing 24, end washer 46 and retaining pin 48. The torque hub portion 72 is finished suitable as a bearing surface and a raised thrust shoulder element processed or secondary machined for future assembly. The torsion bar portion 76 has desired geometric shape, stressed reduced ends formed at torque hub portion 72 and countertorque hub portion 74, and are uniformly twisted in torsion. Countertorque hub portion 74 conforms to axle tube 8 interior and distributes induced torque reaction to axle tube 8 walls. As torsion bar portion 76 contract from induced twisting, countertorque hub portion 74 axially floats within axle tube 8.

Bearing housing 22 has continuous bearing surface within bore and thrust bearing faces to work against thrust shoulder element and demountable torque arm 50 faces. Bearing surfaces may be dry lubricant type, or have compatible lubricant injected after assembly to provide adequate film between all surfaces. If desired, a seal groove may be processed within bearing surface for a radial seal 35, O-ring, lip seal, and the like, to prohibit debris from entering and damaging journal element and bearing housing 22 surfaces. Eliminated are dual torque tube bearings 24. Bearing housing 22 conforms to axle tube 8 interior and is held in place with typical fastener 62, cartridge bolts, dowel pins and retaining straps and the like. Bearing housing 22 slides over torque hub portion 72 and stops against thrust shoulder element to allow torque subassembly 70 oscillation and maintain wheel camber. Demountable torque arm 50 fits over and secures to exposed torque hub portion 72. Securing methods for demountable torque arm 50 onto torque hub portion 22 include simple cross bolt and nut, indexable spline with fasteners, and the like. Demountable spindle 55 secures to demountable torque arm 50 for proper alignment with taper-fit and nut, mounting flange and fasteners, and the like.

The one piece torque subassembly can be configured to provide the torsion bar portion 76 is placed inside a tubular torque hub portion 72 reducing the overall length for same performance thereby having a compact design. Torsion bar elements 36 can be reduced in number by terminating desired molding or injection ports, and the like, during production or selected removal means, such as cutting, after production.

The integral torsion spring assembly 70 is a one-piece unit in combination of individual parts, including the spindle 55, torque arm 50, torque hub portion 72, torsion bars portion 76 and countertorque hub portion 74. The ability to produce a one-piece operating torsion assembly is a significant decrease in manufacturing, processing, finishing, and assembly requirements and their resulting accrued costs as previously experienced in other designs. Further, the integral torsion assembly one-piece unit is substantially less in weight for the same operational performance as with other typical designs. The torque arm section 50 radial position in reference to the opposite end countertorque hub portions 74 can be indexed as desired for wheel position, with respect to chassis, and as process tooling permit.

The one piece torque subassembly can be composed of a composite material, such as reinforced fiber plastics or other non-ferrous material. The composite material can be machined, molded or extruded as determined by the manufacturer of the assembly.

Prior art torsion designs have included an internal torsion limiter to prevent overstressing the torsion bars. Although a logical concept, it is actually an impractical practice in means of performance and capability for assembly size and weight. Torsion bars are typically overstressed into a preset condition, as in automotive and military tank-type vehicles, for increased load performance in the direction of the preset and operating stresses higher than the initial elastic limit. As most axle designs have square tubes, the internal mechanisms are typically limited to 20 to 30 degrees torsion operation, thus for 2G design limits, the rated loading is essentially 10 to 15 degrees from no-load position. Also, mechanisms constrained in typical axle tubes are often subjected to 3 to 5:1 mechanical advantage from wheel loading. This all results in poor load capacity for axle weight and cost, and poor use of energy capacity for given material and size.

To prevent overloading torsion systems, the spindle 55 is sufficiently extended through the torque arm 50 and at extreme design position it impacts a frame or bracket mounted bump stop. This results in a 1:1 mechanical condition and full torsion system design displacement and limits for slight additional material cost and simple bump stop. Bump stop can be any abrupt energy absorbing device or material, such as a molded rubber or plastic block, heavy compression spring, and the like. This simple system allows full use of torsion system capacity for material weight and cost.

Another way to achieve the same result is to design into the torsion system, especially torsion bars, cosine function through displacement practice. The best vehicle ride is achieved when torque arm 50 is at 0 degrees horizontal position, making full use of the pivot radius from torsion center to wheel and spindle center. As a bump induces torsion operation, the cosine function reduces the torque load into and from the torsion action because of cosine function. To compensate for this to some effect is having the torque arm 50 about 20 degrees below torsion center horizontal, resulting in the cosine being 94% of full radius. Designs for torsion action, such as torsion bars and the like, have to be long enough to allow desired performance and extreme loading displacement, for example 60 degrees. Sixty degrees from 0 degree position, this reduces the induced torque effect into and from the torsion action to 50% full radius. The case in being 20 degrees below torsion center results now in the induced torque effect into and from the torsion action to about 76.5% full radius. These are significant reductions in effective torque applied to the torsion action, yet allows much greater displacement to absorb loads in providing better ride quality. Further, the torsion action, especially torsion bars and the like, are increasing in load capacity as displacement increases, thus in combination mechanically performing extreme load capacity without overstressing torsion action and exceeding torsion design stresses.

Typically all sprung and torsion systems have been transverse in application, much like that in a trailer, where the axle is normal to the trailer centerline. Open trailers, and other similar machines, cannot have any interference for application function, including a transverse axle. No energy absorbing suspension currently exists to operate in so confined a space. As disclosed herein, there is provided a torsion spring cartridge 20 configured for installation into a frame rail 8 structure parallel to the trailer direction of travel that is capable in accepting induced loads. In lieu of typical torque arm 50 is a torsion arm 9 and it is equally attached to the torsion spring cartridge 20 assembly. Distanced and normal to it is a cross shaft arm that is in turn attached to cross shaft. Between the two arms is a captured shuttle link that maintains linkage between them, such as captured ball and socket joints. Outside of the frame 8 and attached to the cross shaft is a torque arm 50 that moves with the wheel. This shuttle link between cross shaft arm and torsion arm allows for torsion spring cartridge 20 loading and unloading at right angle to torque arm operation. Further, this is done with independent wheel action from others and in a confined space.

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A torsion spring cartridge for an axle tube, the torsion spring cartridge comprising:
a bearing housing configured to be removably mounted in a non-rotating relation in the axle tube;
a torque arm including a torque hub defining a plurality of pockets and mounted for reciprocal rotatable motion in the bearing housing and a draw bar coupled to the torque hub;
a counter-torque hub configured to be positioned in the axle tube in a spaced relation to the torque hub and in a non-rotating relation to the axle tube, the counter-torque hub composed of a plurality of plates configured to receive the draw bar and defining a plurality of pockets; and
at least two torsion bars mounted between the torque arm and the counter-torque hub for biasing the torque arm to a neutral position, the bearing housing, torque arm, torsion bars and counter-torque hub being removable as a unit from the axle tube for service, replacement or repair, wherein the torsion bars are not fixedly mounted in the torque hub pockets and counter-torque hub pockets.

2. The torsion spring cartridge of claim 1, including a washer, with the washer configured to mount on the draw bar and retain the torsion bars within the counter-torque hub and a retaining fastener coupled to the draw bar to retain the washer.

3. The torsion spring cartridge of claim 1, wherein the torsion bars have a uniform cross section.

4. The torsion spring cartridge of claim 1, wherein the axle tube is aligned traverse to the direction of travel.

5. The torsion spring cartridge of claim 1, wherein the axle tube is aligned parallel to the direction of travel.

6. The torsion spring cartridge of claim 3, wherein the torsion bars have a square cross section.

7. An axle kit for a trailer, with the trailer including a frame, the kit comprising:
an axle tube having two open ends and configured to couple to the frame; and
a torsion spring cartridge mounted in at least one end of the axle tube, wherein the torsion spring cartridge includes:
a bearing housing configured to be removably mounted in a non-rotating relation in the axle tube;
a torque arm including a torque hub defining a plurality of pockets and mounted for rotary motion in the bearing housing and a draw bar coupled to the torque hub;
a counter-torque hub configured to be positioned in the axle tube in a spaced relation to the torque hub and in a non-rotating relation to the axle tube, the counter-torque hub composed of a plurality of plates configured to receive the draw bar and defining a plurality of pockets; and
at least two torsion bars mounted between the torque arm and the counter-torque hub for biasing the torque arm to a neutral position, the bearing housing, torque arm, torsion bars and counter-torque hub being removable as a unit from the axle tube for service, replacement or repair, wherein the torsion bars are not fixedly mounted in the torque hub pockets and counter-torque hub pockets.

8. The axle kit of claim 7, including a washer, with the washer configured to mount on the draw bar and retain the torsion bars within the counter-torque hub and a fastener coupled to the draw bar to retain the washer.

9. The axle kit of claim 7, wherein the torsion bars have a uniform cross section.

10. The axle kit of claim 7, wherein the axle tube is aligned traverse to the trailer frame.

11. The axle kit of claim 7, wherein the axle tube is aligned parallel to the trailer frame.

12. The axle kit of claim 7, including a second torsion spring cartridge mounted in another end of the axle tube.

13. The axle kit of claim 9, wherein the torsion bars have a square cross section.

14. A torsion spring cartridge for an axle tube, the torsion spring cartridge comprising:
a bearing housing configured to be removably mounted in a non-rotating relation in the axle tube;
a torque arm mounted for rotary motion in the bearing housing and;
an integral, one piece torque subassembly having a torque hub portion attached to the torque arm and a counter-torque hub portion coupled to the torque hub portion with a plurality of torsion bar portions in a spaced apart relation, with the one piece torque subassembly configured to mount inside the axle tube in a non-rotating relation to the axle tube, wherein the one piece torque subassembly biases the torque arm to a neutral position.

15. The torsion spring cartridge of claim 14, wherein the torsion bar portions have a uniform cross section.

16. The torsion spring cartridge of claim 14, wherein the axle tube is aligned traverse to the direction of travel.

17. The torsion spring cartridge of claim 14, wherein the axle tube is aligned parallel to the direction of travel.

18. The torsion spring cartridge of claim 14, wherein the one piece torque subassembly is composed of a composite material.

19. The torsion spring cartridge of claim 14, including a second torsion spring cartridge mounted in the axle tube a space apart relation to the other torsion spring cartridge.

20. The torsion spring cartridge of claim 15, wherein the torsion bar portions have a square cross section.
